(19) United States
(12) Patent Application Publication
(10) Pub. No.: US 2024/0011129 A1
(43) Pub. Date: Jan. 11, 2024

(54) ALLOY, POWDER, DUCTILE GAMMA' ADHESION PROMOTER LAYER AND COMPONENT

(71) Applicant: Siemens Energy Global GmbH & Co. KG, München (DE)

(72) Inventor: Arturo Flores Renteria, Berlin (DE)

(21) Appl. No.: 18/251,916

(22) PCT Filed: Oct. 5, 2021
(86) PCT No.: PCT/EP2021/077444

§ 371 Date: May 5, 2023

(30) Foreign Application Priority Data
Nov. 5, 2020 (DE) 10 2020 213 918.0

(51) Int. Cl. C22C 19/05; B22F 1/10; C23C 4/073; C23C 28/00

(52) U.S. Cl. CPC C22C 19/058; B22F 1/10; C23C 4/073; C23C 28/3215; C23C 28/3455; B22F 2999/00; B22F 2301/15

(57) ABSTRACT

An adhesion promoter layer is produced by a novel composition with a lower cobalt content in an MCrAlY alloy. The adhesion promoter layer leads to a very slow growth of the TGO. The nickel-based alloy contains at least (in wt. %): cobalt (Co) 0.2%-5.0%, chromium (Cr) 14.0%-20.0%; aluminum (Al) 6.0%-8.0%; tantalum (Ta) 1.0%-3.0%; yttrium (Y) 0.3%-0.6%; nickel (Ni) 70.0%-75.0%.

The invention relates to an alloy, to a powder, to a ductile adhesion promoter layer, and to a component.

The thermomechanical behavior of metallic adhesion promoter layers on substrates has a direct influence on the performance of ceramic thermal barrier coating systems which in the case of turbine components comprise a nickel- or cobalt-based substrate, the adhesion promoter layer, and at least one ceramic layer (TBC) over it.

These metallic adhesion promoter layers have a number of strict criteria to meet, such as protection from oxidation, long-term thermal stability, strength, and ductility.

Particularly for hydrogen turbines, the thermal barrier coating system is subject to a different requirement.

It is therefore an object of the invention to solve the problem stated above.

The object is achieved by an alloy as claimed in claim 1, a powder as claimed in claim 2, a layer as claimed in claim 3, and a component as claimed in claim 4.

The dependent claims list further advantageous measures, which may be combined with one another as desired in order to achieve further advantages.

The invention comprises a nickel-based alloy, more particularly consisting of (in wt %):

| | |
|---|---|
| cobalt (Co) | 0.2%-5.0%, |
| more particularly | 1.0%-4%; |
| chromium (Cr) | 14.0%-20.0%, |
| more particularly | 16.0%-18.0%; |
| aluminum (Al) | 6.0%-8.0%, |
| more particularly | 7.0%; |
| tantalum (Ta) | 1.0%-3.0%, |
| more particularly | 2.0%; |
| yttrium (Y) | 0.3%-0.6%; |
| nickel (Ni) | 64.0%-79.0%, |
| more particularly | 70.0%-75.0%. |

Notable and necessary is the low cobalt (Co) content.

Impurities are always present in the alloy.

The γ′-containing adhesion promoter layer slows down the growth of the aluminum oxide layer (TGO) and is able as a result to improve the thermal-cyclical lifetime of an overlying ceramic layer (TBC) or coating system (substrate+NiCoCrAl+optionally TBC).

A powder composed of the alloy may optionally comprise binders of other particles such as, in particular, ceramic or refractory particles.

A component, more particularly for a hydrogen-driven gas turbine, comprises a substrate.

The substrate preferably comprises a nickel- or cobalt-based alloy.

Applied atop this is the alloy of the invention, based on NiCoCrAlYTa.

This may be done by means of methods from the prior art, more particularly by means of HVOF and APS.

Likewise conceivable are two-layer NiCoCrAlY protective coats, in which the alloy of the invention preferably forms the outer part.

A TGO forms on this system in operation or as early as during ceramic coating.

A ceramic coating (TBC) on the NiCoCrAlYTa may have a one-layer or two-layer configuration.

Stabilized zirconium oxide preferably constitutes the basis for the TBC.

1-8. (canceled)

9. A nickel-based alloy, comprising (in wt %):

| | |
|---|---|
| cobalt (Co) | 0.2%-5.0%; |
| chromium (Cr) | 14.0%-20.0%; |
| aluminum (Al) | 6.0%-8.0%; |
| tantalum (Ta) | 1.0%-3.0%; |
| yttrium (Y) | 0.3%-0.6%; and |
| nickel (Ni) | 64.0%-79.0%. |

10. The nickel-based alloy according to claim 9, wherein said chromium (Cr) is 14% to 16% (in wt %).

11. The nickel-based alloy according to claim 9, wherein said chromium (Cr) is 16% to 18% (in wt %).

12. The nickel-based alloy according to claim 9, wherein said chromium (Cr) is 18% to 20 (in wt %).

13. The nickel-based alloy according to claim 9, wherein (in wt %):

| | |
|---|---|
| said cobalt (Co) | 1.0%-4%; |
| said chromium (Cr) | 16.0%-18.0%; |
| said aluminum (Al) | 7.0%; |
| said tantalum (Ta) | 2.0%; and |
| said nickel (Ni) | 70.0%-75.0%. |

14. The nickel-based alloy according to claim 9, wherein the nickel-based alloy consisting of (in wt %):

| | |
|---|---|
| said cobalt (Co) | 0.2%-5.0%; |
| said chromium (Cr) | 14.0%-20.0%; |
| said aluminum (Al) | 6.0%-8.0%; |
| said tantalum (Ta) | 1.0%-3.0%; |
| said yttrium (Y) | 0.3%-0.6%; and |
| said nickel (Ni) | 64.0%-79.0%. |

15. A powder, comprising (in wt %):

| | |
|---|---|
| cobalt (Co) | 0.2%-5.0%; |
| chromium (Cr) | 14.0%-20.0%; |
| aluminum (Al) | 6.0%-8.0%; |
| tantalum (Ta) | 1.0%-3.0%; |
| yttrium (Y) | 0.3%-0.6%; and |
| nickel (Ni) | 64.0%-79.0%. |

16. The powder according to claim 15, wherein said chromium (Cr) is 14% to 16% (in wt %).

17. The powder according to claim 15, wherein said chromium (Cr) is 16% to 18% (in wt %).

18. The powder according to claim 15, wherein said chromium (Cr) is 18% to 20 (in wt %).

19. The powder according to claim 15, wherein (in wt %):

| | |
|---|---|
| said cobalt (Co) | 1.0%-4%; |
| said chromium (Cr) | 14.0%-20.0%; |
| said aluminum (Al) | 6.0%-8.0%; |
| said tantalum (Ta) | 1.0%-3.0%; and |
| said nickel (Ni) | 70.0%-75.0%. |

20. The powder according to claim 15, further comprising:
a binder; and
secondary particles or ceramic particles.

21. The powder according to claim 15, wherein the powder consisting of (in wt %):

| | |
|---|---|
| said cobalt (Co) | 0.2%-5.0%; |
| said chromium (Cr) | 14.0%-20.0%; |
| said aluminum (Al) | 6.0%-8.0%; |
| said tantalum (Ta) | 1.0%-3.0%; |
| said yttrium (Y) | 0.3%-0.6%; and |
| said nickel (Ni) | 64.0%-79.0%. |

22. A metallic layer, comprising (in wt %):

| | |
|---|---|
| nickel (Ni) | 64.0%-79.0%; |
| cobalt (Co) | 0.2%-5.0%; |
| chromium (Cr) | 14.0%-20.0%; |
| aluminum (Al) | 6.0%-8.0%; |
| tantalum (Ta) | 1.0%-3.0%; and |
| yttrium (Y) | 0.3%-0.6%. |

23. The metallic layer according to claim 22, wherein:

| | |
|---|---|
| said nickel (Ni) | 70.0%-75.0%; |
| said cobalt (Co) | 1.0%-4%; |
| said chromium (Cr) | 16.0%-18.0%; |
| said aluminum (Al) | 7.0%; and |
| said tantalum (Ta) | 2.0%. |

24. The metallic layer according to claim 22, wherein the metallic layer containing at least to an extent of 90%:

| | |
|---|---|
| said nickel (Ni) | 64.0%-79.0%; |
| said cobalt (Co) | 0.2%-5.0%; |
| said chromium (Cr) | 14.0%-20.0%; |
| said aluminum (Al) | 6.0%-8.0%; |
| said tantalum (Ta) | 1.0%-3.0%; and |
| said yttrium (Y) | 0.3%-0.6%. |

25. The metallic layer according to claim 22, wherein the metallic layer containing at least to an extent of 95%:

| | |
|---|---|
| said nickel (Ni) | 64.0%-79.0%; |
| said cobalt (Co) | 0.2%-5.0%; |
| said chromium (Cr) | 14.0%-20.0%; |
| said aluminum (Al) | 6.0%-8.0%; |
| said tantalum (Ta) | 1.0%-3.0%; and |
| said yttrium (Y) | 0.3%-0.6%. |

26. The metallic layer according to claim 22, wherein a balance from said nickel (Ni).

27. The metallic layer according to claim 22, wherein the metallic layer is produced from a powder containing (in wt %):

| | |
|---|---|
| said nickel (Ni) | 64.0%-79.0%; |
| said cobalt (Co) | 0.2%-5.0%; |
| said chromium (Cr) | 14.0%-20.0%; |
| said aluminum (Al) | 6.0%-8.0%; |
| said tantalum (Ta) | 1.0%-3.0%; and |
| said yttrium (Y) | 0.3%-0.6%. |

28. A component, comprising:
a substrate formed from a nickel-based alloy, a metallic layer of said nickel-based alloy or a powder, said nickel-based alloy, said metallic layer of said nickel based alloy or said powder each containing (in wt %):

| | |
|---|---|
| cobalt (Co) | 0.2%-5.0%; |
| chromium (Cr) | 14.0%-20.0%; |
| aluminum (Al) | 6.0%-8.0%; |
| tantalum (Ta) | 1.0%-3.0%; |
| yttrium (Y) | 0.3%-0.6%; and |
| nickel (Ni) | 64.0%-79.0%. |

29. The component according to claim 28, further comprising a ceramic thermal barrier layer.

30. The component according to claim 29, wherein said ceramic thermal barrier layer is based on zirconium oxide.

31. The component according to claim 28, wherein said chromium (Cr) is 14% to 16% (in wt %).

32. The component according to claim 28, wherein said chromium (Cr) is 16% to 18% (in wt %).

33. The component according to claim 28, wherein said chromium (Cr) is 18% to 20 (in wt %).

34. The component according to claim 28, wherein the component is configured for hydrogen-driven gas turbines.

35. The component according to claim 29, wherein said ceramic thermal barrier layer is disposed on said metallic layer.
